(19) United States
(12) Patent Application Publication
(10) Pub. No.: US 2019/0272491 A1
(43) Pub. Date: Sep. 5, 2019

(54) INVENTORY PLACEMENT RECOMMENDATION SYSTEM

(71) Applicant: Walmart Apollo, LLC, Bentonville, AR (US)

(72) Inventors: Amlan Jyoti Das, Bangalore (IN); Shreyan Ghosh, Kolkata (IN); Souraj Mishra, Bangalore (IN)

(21) Appl. No.: 15/953,346

(22) Filed: Apr. 13, 2018

(30) Foreign Application Priority Data
Mar. 1, 2018 (IN) 201841007781

(51) Int. Cl. G06Q 10/06; G06Q 10/08

(52) U.S. Cl. CPC G06Q 10/06313; G06Q 10/087

(57) ABSTRACT

The system and method described herein enable generating inventory placement recommendations for a store based on transaction data. Inventory data associated with the individual store is obtained. The inventory data includes container location data, item location data, item category data, and transaction data. A store layout model of the store is generated based on the container location data and item location data. Item category relationships are calculated based on the transaction data and the item category data. Inventory layouts are generated based on the store layout model and the calculated item category relationships. Average distance values for each inventory layout are calculated, and an inventory placement recommendation is generated based on the average distance values of the inventory layouts. The generated inventory placement recommendation enables arrangement of the inventory of the store based on past transactions to reduce the average travel distance of customers when shopping there.

### BACKGROUND

In many stores, such as department stores, grocery stores, or the like, the arrangement of items on the shelves and other containers within the store is an important factor in providing customers with positive shopping experiences. The arrangement of items in the store influences whether customers can find the items they're looking for, how long shopping trips in the store take, how far customers must travel in the store to obtain all the items they want, how congested the aisles of the store get during busy hours, etc. While store managers or others who may select the layout of the store may be experienced enough to identify many aspects of effective inventory arrangement, it is likely that there may be many customer behavior patterns that go unnoticed that may influence the inventory layout if recognized. Further, even if a customer behavior pattern were recognized, it is difficult to determine what changes to the inventory layout may be necessary to account for the recognized behavior pattern.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for providing inventory placement recommendations is described. The method comprises obtaining, by an inventory placement component, inventory data associated with an individual store. The inventory data includes container location data, item location data, item category data, and transaction data. A store layout model of the store is generated based on the container location data and item location data. Item category relationships are calculated based on the transaction data and the item category data. Inventory layouts are generated based on the store layout model and the calculated item category relationships. Average distance values for each inventory layout are calculated, and an inventory placement recommendation is generated based on the average distance values of the inventory layouts.

Many of the attendant features will be more readily appreciated as the same becomes better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 is an exemplary block diagram illustrating a system configured for generating inventory placement recommendations based on inventory data according to an embodiment;

FIG. 2 is an exemplary block diagram illustrating an inventory placement module configured to obtain inventory data and generate inventory placement recommendations therefrom according to an embodiment;

FIGS. 3A-3B are exemplary block diagrams illustrating an initial store layout model with an initial inventory layout and an associated inventory placement recommendation respectively, according to an embodiment;

FIG. 4 is an exemplary flow chart illustrating a process of generating an inventory placement recommendation according to an embodiment; and

FIG. 5 illustrates a computing apparatus according to an embodiment as a functional block diagram.

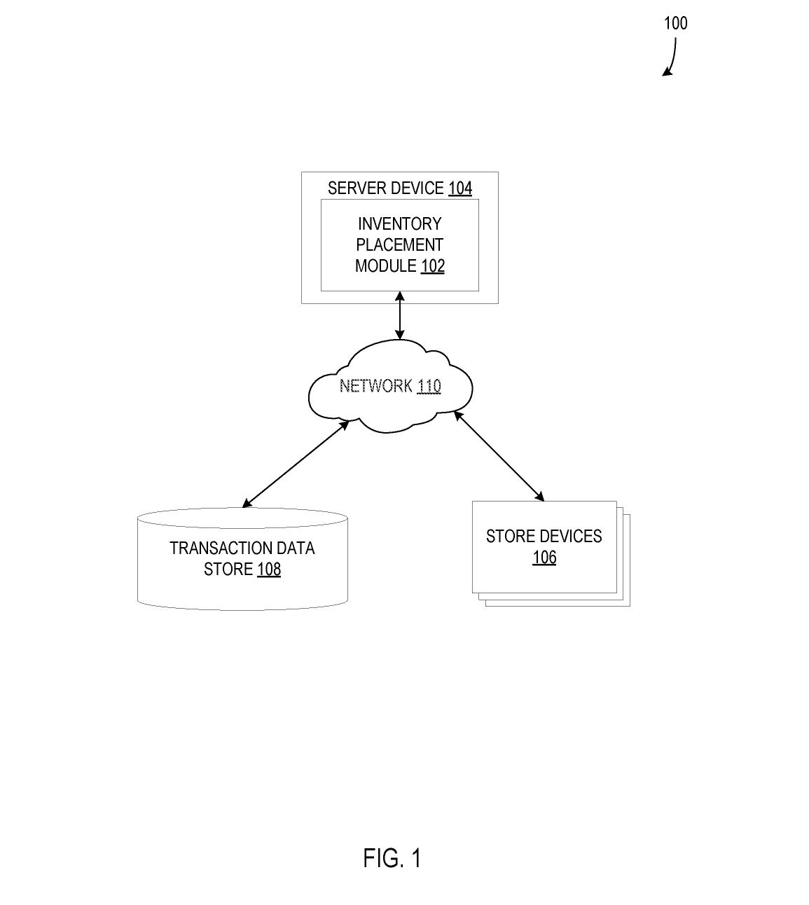

Corresponding reference characters indicate corresponding parts throughout the drawings. In FIGS. 1 to 5, the systems are illustrated as schematic drawings. The drawings may not be to scale.

### DETAILED DESCRIPTION

The systems and methods described herein are configured for generating inventory placement recommendations based on past transaction data. An inventory placement component obtains inventory data associated with an individual store. The inventory data includes container location data, item location data, item category data, and transaction data. The inventory placement component then generates a store layout model of the store based on the container location data and the item location data. A number of item category relationships are calculated based on the transaction data and the item category data. The generated store layout model and the calculated item category relationships are then used to generate a plurality of inventory layouts. Average distance values for each of the inventory layouts are the calculated based on the transaction data. An average distance value indicates an average distance traveled (e.g., a distance value in feet, meters, or other units, etc.) in a store arranged according to the associated inventory layout to obtain items of the transactions of the transaction data. Finally, an inventory placement recommendation is generated based on the average distance values of the plurality of inventory layouts.

The described disclosure improves the process of determining an inventory layout of a store by providing recommendations that are based on past item purchase patterns of customers. The provided recommendations are the result of analysis of a store layout based on past transaction data and any constraints associated with the containers and/or items of the store. A large number of possible permutations of inventory layouts are analyzed, enhancing the likelihood that the recommended layout is an optimal layout for the purchasing behaviors of customers at the store. Further, store managers or others who are responsible for the arrangement of the store are enabled to make informed decisions about selecting a layout based both on predicted customer travel distance and on rearrangement cost estimates.

The described invention provides efficient computational analysis of multiple store inventory-based data sets and improved generation and handling of substantial numbers of store layouts based on determined item category relationships. As a result, effective inventory layouts may be efficiently identified from a large number of possible inventory layouts using the processes and methods described herein.

FIG. 1 is an exemplary block diagram illustrating a system 100 configured for generating inventory placement recommendations based on inventory data according to an embodiment. The system 100 includes an inventory placement module 102, one or more store devices 106, and a transaction data store 108 connected to each other via a network 110.

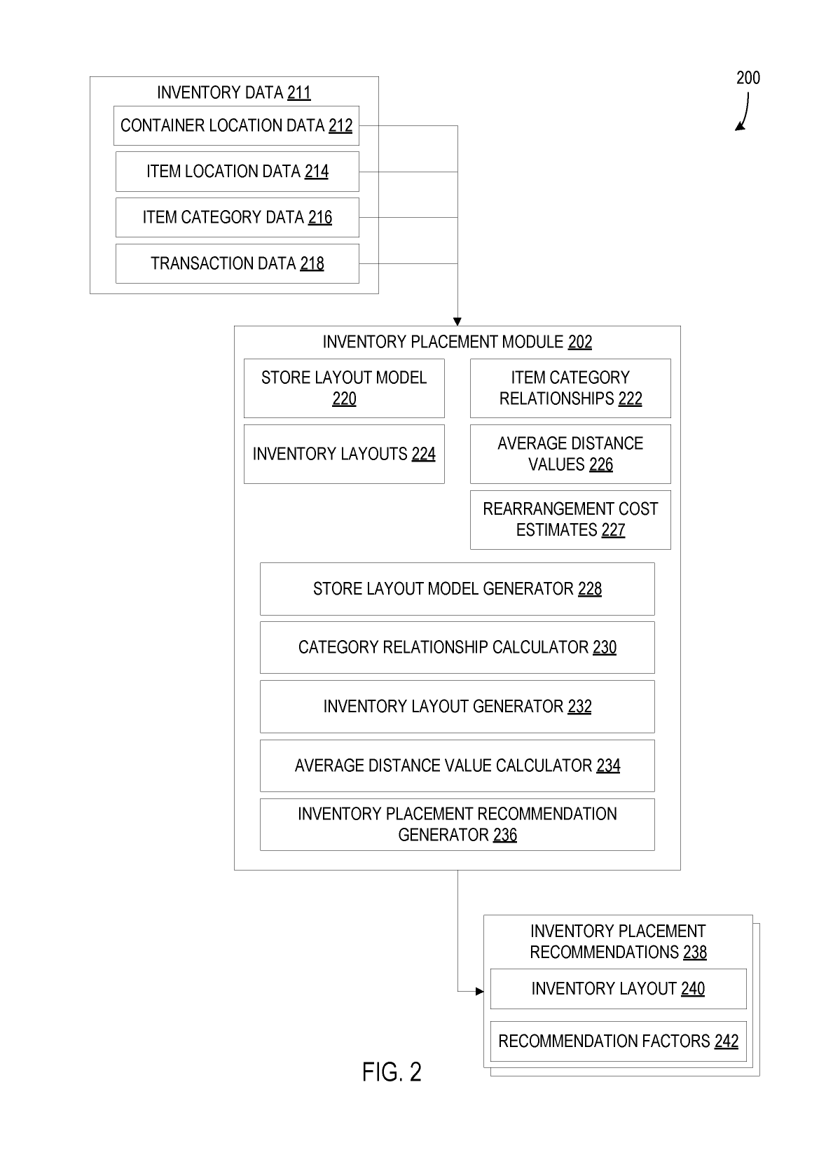

The inventory placement module 102 includes software, firmware, and/or hardware components configured for obtaining store-specific inventory data (e.g., container location data, item location data, item category data, transaction data, etc.) and generating store-specific inventory placement recommendations based on the obtained inventory data as described herein. The inventory placement module 102 may be a software application that is disposed on and executed by server device 104, which may be a computing device, such as a desktop computer or the like. The specific functionality of the inventory placement module 102 is described in greater detail below with respect to FIG. 2.

Generally, a computing device may include a mobile computing device or any other portable device, such as a mobile telephone, laptop, tablet, computing pad, netbook, gaming device, and/or portable media player. The computing device may also include less portable devices such as desktop personal computers, kiosks, tabletop devices, industrial control devices, wireless charging stations, and electric automobile charging stations. Additionally, the computing device may represent a group of processing units or other computing devices, such as a server or set of servers, or a distributed computing environment that includes any of the above systems or devices.

The store devices 106 may include one or more computing devices located at and/or associated with one or more stores (e.g., grocery stores, department stores, electronic stores, clothing stores, etc.). Each store may have or be associated with one or more of the store devices 106. For instance, a store manager may have a personal computer in an office that is connected via the network 110 to the inventory placement module 102 and the transaction data store 108. Each store has a physical layout of shelves, bins, tables, or other containers, aisles, registers, customer service desks, bathrooms, entrances, exits, etc. which may be represented in the form of store-specific inventory data stored on the store devices 106. For instance, the inventory data may include dimensions of the store, and the locations of the various containers and other objects in the store relative to the store dimensions (e.g., using 2 dimensional coordinates, distance measurements, etc.). The inventory data may also include a current inventory layout (e.g., the locations of inventory items on the shelves and/or in the containers of the store, etc.). In some examples, the store-specific inventory data includes transaction data for an individual store. In other examples, the store-specific transaction data may be stored separately from the other inventory data, as described below. The store-specific inventory data may be dynamically updated as the physical layout or inventory arrangement of a store changes.

Inventory data and/or other store-based data may be entered into the store devices 106 manually by a store manager, employee or other user. Alternatively, or additionally, inventory data may be entered into store devices 106 using scanners (e.g., a user scanning barcodes on items and/or containers to associate the items with containers, etc.), sensors (e.g., radio frequency identification (RFID) sensors used to detect nearby items and/or nearby containers, sensors used to detect a user's location in the store, etc.), distance-measuring devices (e.g., an electronic distance-measuring device used to detect distances between shelves and other containers, etc.), motion-sensing devices (e.g., a pedometer used to detect distance in steps between locations in a store, etc.), or the like. Once a set of inventory data and/or other store-based data is collected and saved to the store devices 106, changes to the data may be done through minor adjustments, rather than more extensive data collection processes.

Store devices 106 are configured to communicate with the inventory placement module 102 and to provide the inventory data defining the store layout and inventory arrangement to the inventory placement module 102 as described herein. Further, store devices 106 may receive inventory placement recommendations from the inventory placement module 102 and display or otherwise output the received recommendations to a user (e.g., a manager, etc.) at the stores. In some examples, store devices 106 are configured to send transaction data for transactions that occur at the store to the transaction data store 108. Alternatively, or additionally, a store may include multiple store devices 106 (e.g., point-of-sale (POS) terminals, tablets, etc.) that automatically upload transaction data to the transaction data store 108.

The transaction data store 108 includes software, firmware, and/or hardware configured for storing transaction data from one or more stores. The transaction data store 108 may include a data structure, such as a database, stored in memory of one or more computing devices (e.g., server devices, etc.). The transaction data store 108 is configured for communication with the inventory placement module 102 and the store devices 106 via the network 110 (e.g., to provide the inventory placement module 102 and/or the store devices 106 with transaction data stored thereon, etc.). In some examples, the transaction data store 108 may be configured for communication with other computing devices via the network 110 or other networks.

The transaction data store 108 stores transaction data for transactions that occur at one or more stores. The transaction data may include store identifiers of stores at which the transactions occur, transaction dates, transaction amounts, payer account data, item data associated with items purchased in the transaction, etc. In some examples, the transaction data from each store or store device 106 is stored in a single transaction data store 108. Alternatively, multiple transaction data stores 108 may be used to store transaction data from multiple stores (e.g., each store may have an associated transaction data store 108, etc.). Further, the transaction data store 108 may include transaction data from online stores or the like.

It should be understood that network 110 may include one or more integrated or otherwise connected networks. The network 110 may include public and/or private networks, large-scale networks, such as the Internet, and/or relatively smaller intranets. The network 110 may be accessed via wired and/or wireless connections, using any and all network protocols as understood by a person of ordinary skill in the art.

In some examples, the inventory placement module 102, transaction data store 108, and other associated software applications may be stored on and/or executed on one or more separate computing devices, such as the server device 104, the store devices 106, etc. Alternatively, the inventory placement module 102 may be stored and/or executed on one or more of the store devices 106. Further, the transaction data store 108 may be stored on one or more of the store devices 106, such that each store device 106 stores transaction data associated with transactions that have occurred at the associated store.

FIG. 2 is an exemplary block diagram illustrating an inventory placement module 202 configured to obtain inventory data 211 and generate inventory placement recommendations 238 therefrom according to an embodiment.

The inventory data 211 may include container location data 212, item location data 214, item category data 216, and transaction data 218. Container location data 212 includes data that represents the physical location of containers (e.g., shelves, bins, tables, or other containers used to display items in a store, etc.) within a store. The container location data 212 may include, for instance, coordinates defining one or more location points of a container, such as a center point, corners, or edges of the container with respect to a defined coordinate system of the store. For example, a coordinate system of a store may define the southwest corner of the store as the (0,0) point of the store and the coordinates of the containers in the store are defined in reference to the (0,0) point. The container location data of a shelf in the store may include a coordinate point of (12 m, 20 m), which may indicate that the shelf is located 12 meters north of the southwest corner and 20 meters east of the southwest corner. Alternatively, or additionally, the container location data of the shelf may include 3 more sets of coordinates, wherein each set of coordinates represents the location of a corner of the shelf. Thus, the footprint of the shelf in the store is represented as a rectangle or other shape that has corners at the coordinate locations. It should be understood that the orientation and units used in the coordinate system of a store may be defined specifically for each store.

It should be understood that, with respect to the exemplary coordinate system described above and any other units of measure used (e.g., meters, feet, pounds, grams, degrees Fahrenheit, etc.), the units used are exemplary and not limiting. In other examples, other units of measure and/or related standards may be used without departing from the description herein. For instance, the container location data 212 may be provided in meters, feet, number of steps, number of blocks, or unitless numeric values based on the coordinate system associated with the store.

The container location data 212 may include dimension data representing the size of the container's footprint within the store (e.g., a display table may have a footprint of 1 meter by 1 meter, while a shelf may have a footprint of 1 meter by 10 meters. The dimension data may also include height, volume, and/or capacity attributes of the container. For instance, container attributes may include maximum weight capacity (e.g., a shelf can hold a maximum of 50 pounds, etc.), total container dimensions (e.g., a table is 3 feet by 10 feet, an item rack has a maximum height of 12 feet, etc.), container opening dimensions (e.g., a cabinet has door dimensions of 3 feet by 2 feet, etc.), operating temperature ranges of temperature-controlled containers (e.g., a refrigerated cabinet operates between 30 and 45 degrees Fahrenheit, a chest freezer display case operates between 10 and 30 degrees Fahrenheit, etc.). It should be understood that container attributes other than the exemplary ones discussed herein may be used without departing from the description herein. The attributes of containers in a store may be used as constraints during the generation of inventory layouts by the inventory layout generator 232 as described herein.

Item location data 214 represents the location of each inventory item in the store. The item location data 214 may include coordinates as described above for the container location data 212. Alternatively, or additionally, the item location data 214 may include a container identifier that identifies the container, shelf, table, or the like on which the item is displayed and/or stored. In some examples, the item location data 214 may include a mapping of an item identifier of the item to a container identifier of the container where the item is physically located, such that the location of the item can be determined by identifying the location of the associated container using the container location data 212.

Item category data 216 includes at least a mapping of an item identifier of an item to a category identifier of an associated item category. Item categories may be assigned to items to enable grouping and/or organizing items that share similar attributes, characteristics, and/or requirements. For instance, clothing or groceries may be two broad categories of items in a store. Further, categories may be defined to be narrower (e.g., milk, cheese, and yogurt categories instead of a broader dairy category, etc.) and/or categories may include sub-categories that divide the items in a category more narrowly (e.g., fruits and vegetables sub-categories within the produce category, etc.).

In addition to organizing groups of similar items, item category data 216 may also include attributes, requirements, or constraints associated with the items in the category. For instance, the item category data of a frozen food category may include an item constraint that the items in the category must be displayed or stored in temperature-controlled containers such as refrigerated shelves or chest freezer displays, etc. Such item constraints may be used by the inventory placement module 202 in generating inventory placement recommendations as described in greater detail below. Other attributes may include category size, item size, item weight, item dimensions, and the like. For example, a hardware category that includes primarily large and/or heavy items may require shelves that provide sufficient space and/or weight capacity for storage and display. In other examples, increased security requirements (e.g., expensive electronic categories may require storage in locked display cases, etc.), other category-specific container requirements (e.g., different item categories within the dairy department may be placed together, etc.), or other user-defined constraints (e.g., items that are considered “impulse buys” may be placed in containers within close proximity to a checkout counter or register, etc.) may be factors used by inventory placement module 202 in determining inventory placement recommendations.

The transaction data 218 includes transaction data as described above with respect to the transaction data store 108. In some examples, the transaction data 218 includes a list or group of item identifiers indicating items purchased during each transaction. The item identifiers may be used with the item category data 216 by the inventory placement module 202 to determine categories of the items and/or with the item location data 214 and/or container location data 212 to determine the locations of the purchased items in the store.

In some examples, the transaction data 218 may include transactions that have occurred over a past time period (e.g., over the last 3 months, over the last 6 months, etc.), over a historical seasonal period (e.g., over the summer months of last year, during a holiday season of last year, etc.), or other defined periods. The transactions may be from a particular store or they may be from a plurality of stores, including physical stores and/or online stores.

The inventory placement module 202 includes intermediate data used in the generation of inventory placement recommendations 238 in the form of a store layout model 220, item category relationships 222, inventory layouts 224, average distance values 226, and rearrangement cost estimates 227. The inventory placement module 202 further includes a store layout model generator 228, a category relationship calculator 230, an inventory layout generator 232, an average distance value calculator 234, and an inventory placement recommendation generator 236.

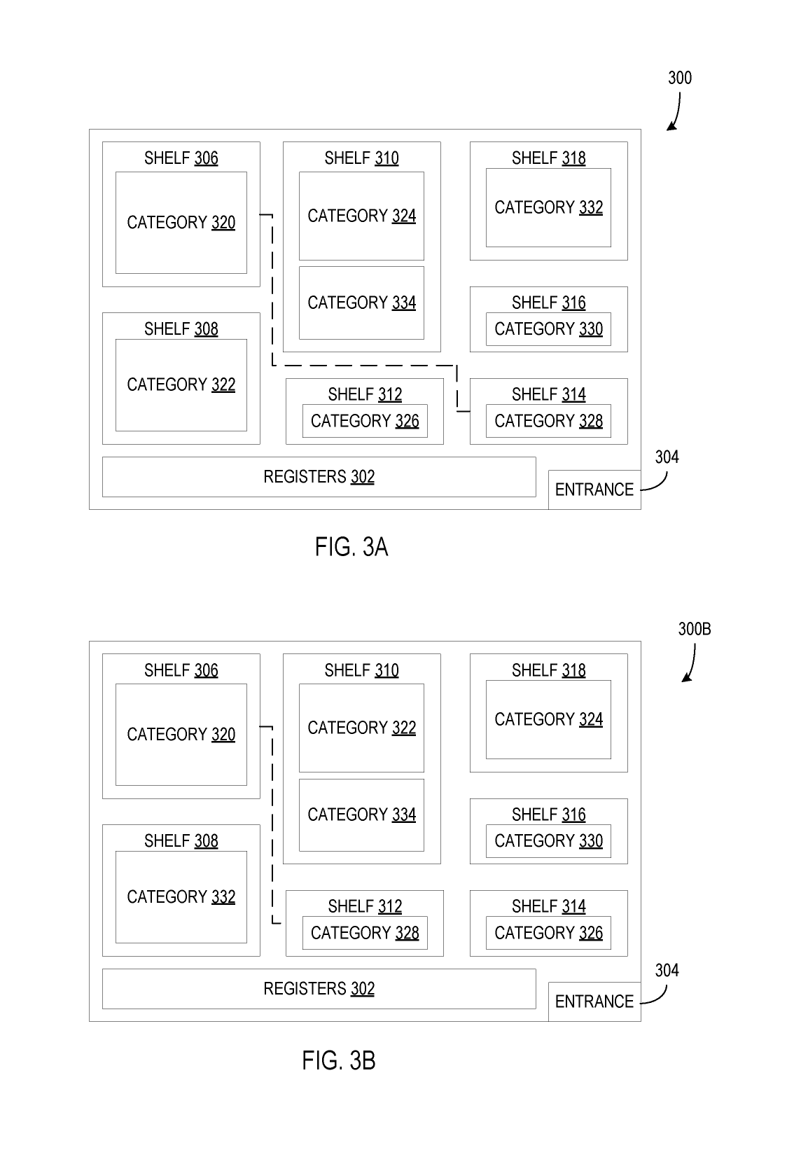

The store layout model generator 228 is a software component configured for generating a store layout model 220 based on the received inventory data 211 for an individual store. The container location data 212 may be used to determine the locations of each container in the store layout model 220. Once the locations of the containers are determined, the store layout model 220 may be represented as a map (e.g., FIGS. 3A-3B, etc.) that illustrates the locations of each container relative to the other containers in the store. The travel distances between each pair of containers in the store may then be calculated, creating a graph representation of the store layout model 220, where each node in the graph represents a container in the store and each edge represents the travel distance between the containers represented by the nodes on either end of the edge. In some examples, calculating travel distance between two containers in the store may be done using the coordinate system of the store of the container location data 212. Areas of the store occupied by containers are assumed to be impassable, such that the path of travel must go around the containers using the areas that exist between the containers (e.g., representing aisles, rows, action alleys, etc.). The travel distance between a first container and a second container may be calculated by starting at a coordinate location on the edge of the first container and tracing a line between the containers to the second container (e.g., in FIG. 3A, the dotted line between Shelf 306 and Shelf 314 represents a possible travel path between the two shelves, etc.). The distances of each portion of the travel path may be summed to calculate the total travel distance between the two shelves (e.g., in FIG. 3A, the distances may include 10 meters south from Shelf 306, 10 meters east between Shelf 310 and Shelf 312, and then 5 meters south to Shelf 314, such that the travel distance between Shelf 306 and Shelf 314 may be calculated as 25 meters, etc.).

When there are multiple travel paths between the containers of the store, the store layout model generator may calculate some or all possible paths and use the shortest path in the graph representation of the store layout model 220.

In alternative examples, other travel distance calculation methods may be used without departing from the description herein. For instance, the store layout model generator 228 may calculate the straight-line distance between two containers, ignoring containers or other obstructions that may interfere with the travel path. This method may be used to simplify the distance calculation at the cost of reduced accuracy of the resulting travel distances.

The item location data 214 and item category data 216 may be used by the store layout model generator 228 to determine the locations of each item and each item category in the store based on the determined locations of the associated containers (e.g., if a shelf is located at or around the coordinates (5 m, 10 m) in the store and an item category is assigned to the shelf, the location of the item category is determined to be at or around the coordinates (5 m, 10 m) as well, etc.).

Upon completion of the generation of the store layout model 220 by the store layout model generator 228, the store layout model 220 includes a map component that includes a representation of the store with an associated coordinate system and locations of each container and associated items and/or item categories within the associated coordinate system. In some examples, the locations of the item categories may be represented by mapping item category identifiers to container identifiers. Further, the store layout model 220 includes the graph component described above that includes nodes for each container and edges between the nodes that represent calculated travel distances between the containers in the store.

In some examples, a generated store layout model 220 may be stored after the inventory placement module 202 completes the described recommendation generation process. A previously generated store layout model 220 may be used for future recommendation generation when some or all of the inventory data 211 of the store remains the same. For instance, when all containers in a store remain in the same locations, a previously generated store layout model 220 may be reused, as the container location portions of the map representation and the graph representation should remain unchanged. The store layout model generator 228 may be configured to compare received inventory data 211 with a previously generated store layout model 220 and update the store layout model 220 based on the received inventory data 211 as necessary instead of generating a new store layout model 220.

The category relationship calculator 230 calculates item category relationships 222 based on the received item category data 216 and the transaction data 218. An item category relationship is a data point that represents a likelihood that items from two categories will be purchased in the same transaction relative to other pairs of two categories. For instance, a higher item category relationship value indicates that the associated pair of item categories are more likely to be purchased together than a pair of item categories that have a lower item category relationship value.

The category relationship calculator 230 calculates item category relationships 222 for each pair of item categories represented in the received item category data 216 based on the transaction data 218. The category relationship calculator 230 analyzes the received transaction data 218 and, for each transaction, increments the item category relationship value associated with each pair of item categories present in the transaction. For instance, if a transaction includes items from Category A, Category B, and Category C, the category relationship calculator 230 increments the item category relationship values associated with the relationships between Category A and Category B, Category B and Category C, and Category A and Category C. Once the transaction data 218 is analyzed, the item category relationships 222 include relationship values that may be compared to determine pairs of item categories that are most likely to be purchased together.

In alternative examples, the calculated values of the item category relationships 222 may be compared to a total number of transactions, a total number of transactions that include at least one of the associated item categories, or the like.

The inventory layout generator 232 is a software component of the inventory placement module 202 that is configured to generate inventory layouts based on the store layout model 220 and associated inventory data 211. An inventory layout 224 represents a permutation of how the store may be arranged (e.g., the containers of the store on which the item categories may be stored and/or displayed, etc.). For example, FIGS. 3A and 3B respectively illustrate an initial inventory layout 224 of a store layout model 220 and an inventory layout 224 that may be recommended by the inventory placement module 202.

In some examples, the inventory placement generator 232 generates all possible permutations of inventory layouts 224. If the item categories of the store layout model 220 do not include additional constraints, the inventory placement generator 232 may generate an inventory layout 224 with each item category located at each possible container or containers within the store. However, in many cases, the item categories may include additional constraints as described above. The inventory placement generator 232 may generate only those inventory layouts 224 that satisfy the constraints of the items and/or item categories of the store. For instance, a frozen food item category may require temperature-controlled storage. If the store includes limited containers that provide the temperature-controlled storage, the inventory placement generator 232 may only generate inventory layouts 224 that include the frozen food item category being located in one of the temperature-controlled containers.

The inventory placement generator 232 may also prioritize placing item categories with high item category relationship 222 values in close proximity to each other when generating inventory layouts 224. For instance, if two pairs of categories have substantially higher value item category relationships 222 than the other pairs of categories (e.g. the pairs are “highly related categories”, etc.), the inventory placement generator 232 may only generate inventory layouts 224 in which highly related item categories are located in adjacent containers and/or within a defined distance threshold of each other (e.g., highly related categories may need to be located at containers within 15 meters of each other, etc.). Such item category relationship 222 limitations may be treated by the inventory placement generator 232 as another constraint, reducing the number of total inventory layouts 224 generated in favor of ensuring that related categories are relatively close together in each inventory layout 224.

The average distance value calculator 234 calculates average distance values 226 for each of the inventory layouts 224 based on the received transaction data 218. For an individual inventory layout, the average distance value calculator 234 calculates the minimum travel distance required for each transaction in the transaction data 218 based on the locations of containers and the associated items and/or item categories within the inventory layout 224. The container locations of the inventory layout 224 may be mapped onto the nodes of the graph component of the store layout model 220 to determine travel distance between containers to retrieve items for the transaction. In some examples, the average distance value calculator 234 calculates all possible travel paths for a transaction to determine the shortest travel path. Alternatively, the average distance value calculator 234 may include travel pathing rules that are followed, reducing the number of possible travel paths calculated by eliminating paths that are unlikely to be shortest (e.g., assuming that items in close proximity are retrieved all at once to eliminate travel paths that go back and forth across the store repeatedly, always pathing to the next closest item to the current location, etc.).

Once travel distances have been calculated for all of the transactions in the transaction data 218, the average distance value calculator 234 calculates the average distance value 226 of the inventory layout 224 (e.g., summing the distance values for each transaction and dividing the result by the total number of transactions, etc.). The average distance value calculator 234 is configured to make this calculation for each inventory layout 224 that has been generated by the inventory layout generator 232 previously, as well as for the current inventory layout represented in the store layout model 220.

The inventory placement recommendation generator 236 generates an inventory placement recommendation 238 based on the inventory layouts 224 and the associated average distance values 226. An inventory placement recommendation 238 may include an inventory layout 240 representing the recommended arrangement of inventory in the store and, optionally, recommendation factors 242 that provide data or information associated with the inventory layout 240. Further, the inventory placement recommendation generator 236 may also include indicators of item categories to be rearranged based on a comparison of the inventory layout of the current store layout model 220 to the selected inventory layout 240. In some examples, the inventory placement recommendation generator 236 generates the inventory placement recommendation 238 by selecting the inventory layout 224 that is associated with the lowest average distance value 226. The inventory placement recommendation 238 may include the selected inventory layout 240 and the average distance value 226 of the selected inventory layout 240 as a recommendation factor 242. Additionally, the recommendation factors 242 may include an amount value and/or percentage value by which the average distance value of the store layout is improved based on the selected inventory layout 240 (e.g., the average distance value is reduced by 20 meters, the average distance value is reduced by 10%, etc.).

In some examples, the inventory placement recommendation generator 236 calculates rearrangement cost estimates 227 based on the layout differences between the current inventory layout of the store and the potential inventory layouts 224. The estimated cost may be based on a number of items and/or categories that would be moved, a size of each item category that must be moved, distance that the items would be moved, labor costs to move the items, an amount of downtime of areas of the store that would be required during rearrangement, predicted lost sales associated with inventory rearrangement, other cost factors associated with rearranging the item categories, etc. The estimated cost factors may be user-defined and associated with specific item categories, specific containers, or both.

The rearrangement cost estimates 227 of potential inventory layouts 224 may be analyzed by the inventory placement recommendation generator 236 when selecting an inventory layout 240 for the inventory placement recommendation 238. For example, a first inventory layout 224 may improve the average distance value of the store by 20% and require that 90% of the item categories be rearranged, which has a high rearrangement cost estimate, and a second inventory layout 224 may improve the average distance value of the store by 19% and require that 10% of the item categories be rearranged, which has a much lower rearrangement cost estimate relative to the first inventory layout 224. The inventory placement recommendation generator 236 may select the second inventory layout 224 for recommendation, even though the improvement of the average distance value is marginally less than the first inventory layout 224, due to the substantially smaller rearrangement cost estimate. The rearrangement cost estimate may be included in the recommendation factors 242 for consideration by store management or other users in reviewing the inventory placement recommendation 238. Further, the inventory placement recommendation generator 236 may use rearrangement cost estimates 227 to eliminate from potential selection inventory layouts 224 that are associated with rearrangement cost estimates that exceed a defined cost threshold (e.g., the inventory placement recommendation generator 236 is configured to recommend an inventory layout if a rearrangement cost estimate is less than $2000, etc.). Alternatively, or additionally, the rearrangement cost estimates 227 may be used to select from multiple potential inventory layouts 224 by combining average distance values 226 and rearrangement cost estimates 227 of individual inventory layouts as a ratio or using another defined formula and comparing the results (e.g., a first inventory layout may improve the average distance value of a store by 2 meters per $1 of rearrangement cost estimate and a second inventory layout may improve the average distance value of a store 1 meter per $1 of estimate rearrangement cost, etc.). For instance, another way of combining the average distance value and rearrangement cost estimate for an individual inventory layout may include applying of coefficients to either data point based on defined rules. Alternatively, or additionally, related threshold requirements may be defined for the average distance values 226 and the rearrangement cost estimates 227 (e.g., if an inventory layout has a rearrangement cost estimate that exceeds $2000, the average distance value must be an improvement of at least 20% over the average distance value of the current store layout model, etc.).

In some examples, the inventory placement recommendation generator 236 may generate an inventory placement recommendation 238 that includes multiple recommended inventory layouts 240 and associated recommendation factors 242. For instance, an inventory placement recommendation 238 may be generated that includes both the first and second inventory layouts 224 from the example described above. This enables store management to select from multiple recommended inventory layouts based on the provided recommendation factors 242 (e.g., a user may be provided with both inventory layouts and recommendation factors that include the average distance value improvement of 20% associated with a 90% item category rearrangement requirement and the average distance value improvement of 19% with a 10% item category rearrangement requirement, respectively, etc.). The multiple recommended inventory layouts 240 may be prioritized or otherwise ordered based on the evaluation of the inventory placement generator 236. Alternatively, or additionally, the multiple recommended inventory layouts 240 may include different categories of recommendations (e.g., the layout with the best improvement per estimated cost ratio, the layout with the best average distance improvement regardless of estimated cost, etc.).

FIGS. 3A-3B are exemplary block diagrams illustrating an initial store layout model 300 with an initial inventory layout and an associated inventory placement recommendation respectively, according to an embodiment. In FIG. 3A, each shelf 306-318 is associated with at least one item category (e.g., item categories 320-334, etc.). Further, the store layout model 300 includes areas for registers 302 (e.g., point-of-sale terminals, self-checkout terminals, etc.) and an entrance 304 of the store. The dotted line between Shelf 306 and Shelf 314 represents a travel path between the two shelves that may be calculated by the inventory placement module 202 as described above. If Category 320 and Category 328 are highly related categories relative to the other item categories, the length of the dotted line travel path may result in an inventory placement recommendation that includes the inventory layout illustrated in FIG. 3B.

FIG. 3B illustrates an inventory layout in the store layout model 300B that may be recommended by an inventory placement module as described herein. Several of the categories have been rearranged, including Category 328 being moved to Shelf 312 from Shelf 314, Category 326 being moved from Shelf 312 to Shelf 314, Category 332 being moved to Shelf 308, Category 322 being moved to Shelf 310, and Category 324 being moved to Shelf 318. The new travel path from Category 320 to Category 328 is shown as a dotted line from Shelf 306 to Shelf 312. The distance between Categories 320 and 328 have been reduced in the recommendation, which may indicate that items from Categories 320 and 328 are purchased together at a high rate, relative to other pairs of item categories. The other category rearrangements may also reflect the item category relationship values between other pairs of categories. Further, some item category rearrangements may be based on relationships of other item categories that may be moved into the containers that the item categories are moved from rather the relationships of the rearranged item category.

It should be understood that the store layout illustrated in FIGS. 3A & 3B is exemplary and that other store layouts and/or arrangements may include more, fewer, or different shelves or other containers that contain more, fewer, or different item categories. Practically, a store layout may have many more specific shelves and other containers that are arranged with greater granularity throughout the store and many more item categories that may be spread throughout the shelves and containers. A single item category may be contained by one or more containers and/or a single container may contain items from one or more item categories.

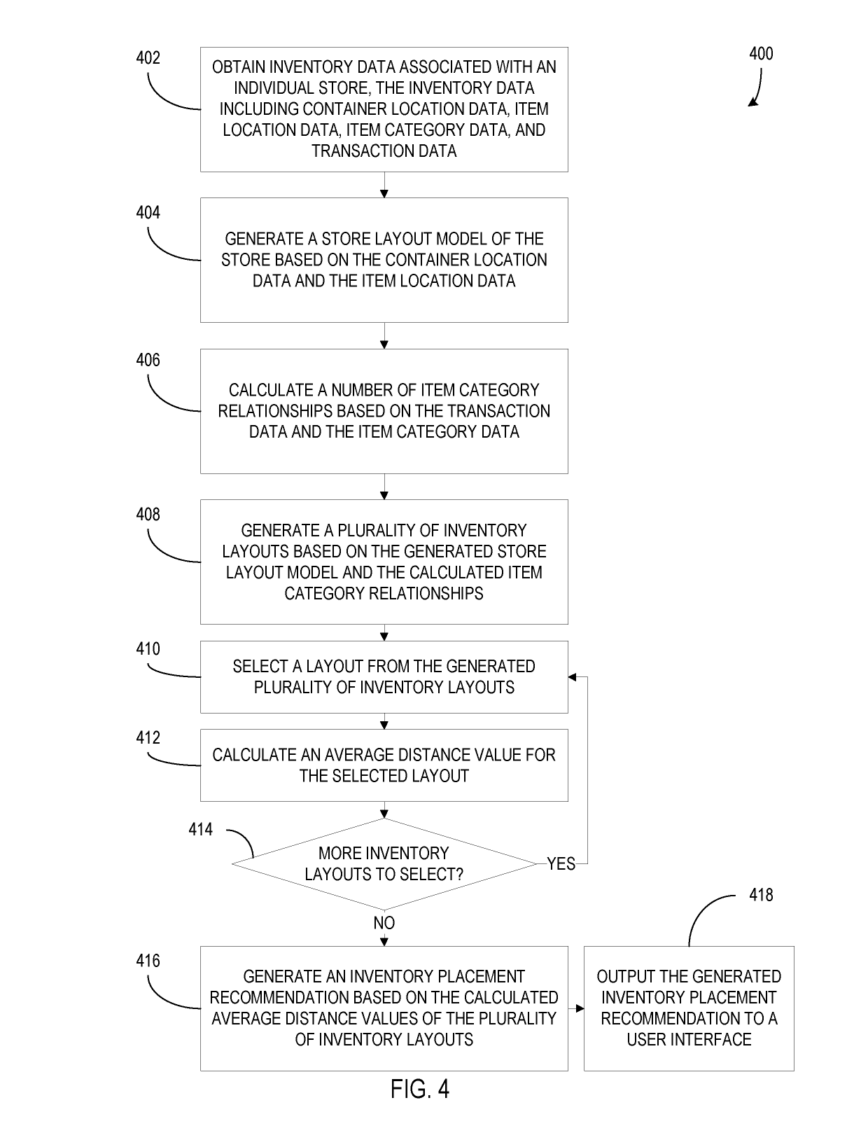

FIG. 4 is an exemplary flow chart 400 illustrating a process of generating an inventory placement recommendation according to an embodiment. The process may be implemented and/or executed by a computing device, such as a personal computer, server, laptop, tablet, and/or a system of devices, such as system 100 in FIG. 1. In some examples, the process of flow chart 400 is executed by an inventory placement module (e.g., inventory placement module 102, 202, etc.) as described herein. At operation 402, inventory data (e.g., inventory data 211, etc.) associated with an individual store is obtained. The obtained inventory data includes container location data (e.g., container location data 212, etc.), item location data (e.g., item location data 214, etc.), item category data (e.g., item category data 216, etc.), and transaction data (e.g., transaction data 218, etc.). In some examples, the inventory data may be obtained by an inventory placement module (e.g., inventory placement module 102, 202, etc.). Obtaining the inventory data may include requesting and/or receiving the inventory data over a network connection (e.g., via a network 110, etc.) or otherwise accessing the inventory data from another application, data store, or data structure.

At operation 404, a store layout model of the store is generated based on the container location data and the item location data. As described herein, in some examples, the generated store layout model may include a map component and/or a graph component. The store layout model includes information that indicates the locations of the containers (e.g., shelves, bins, tables, display cases, etc.) in the store and the locations of items and/or item categories based on the locations of the associated containers and travel distances between the containers of the store. The store layout model may also include other areas or regions beyond containers (e.g., registers 302, entrance 304 in layout 300 of FIGS. 3A-3B, etc.). The store layout model may further include data defining constraints of containers and/or item categories as described herein.

At operation 406, a number of item category relationships are calculated based on the transaction data and the item category data. As described above, in some examples, the item category relationships of pairs of item categories are calculated by determining the number of transactions that include at least one item from each item category in the pair of item categories. The resulting value indicates a likelihood that items from a pair of item categories will be purchased together relative to other pairs of item categories (e.g., a higher value indicates that items from the associated pair of item categories are more likely to be purchased in the same transaction than items in another pair of item categories with a lower value, etc.).

At operation 408, a plurality of inventory layouts is generated based on the generated store layout model and the calculated item category relationships. As described herein, the plurality of generated inventory layouts may include all possible permutations based on the number and/or location of the containers in the store layout model and the number of item categories that must be stored and/or displayed in the containers. Further, the possible permutations may be based on constraints or requirements associated with the containers and/or the item categories (e.g., temperature-controlled containers, frozen food categories, item categories that require a minimum container size and/or volume, etc.). In some examples, the generated inventory layouts may be limited based on the calculated item category relationships, such that only inventory layouts that place highly related pairs of item categories within a defined proximity of each other are generated.

At operation 410, a layout from the generated plurality of inventory layouts is selected. The selected layout may be based on a defined order of the generated plurality of inventory layouts (e.g., the layouts may be prioritized based on the proximity of highly related pairs of item categories, such that layouts with the closest highly related pairs of item categories are chosen before layouts with highly related pairs of item categories located farther apart from each other, etc.). Alternatively, the layout may be selected at random, or based on a different order and/or priority.

At operation 412, an average distance value is calculated for the selected layout. As described herein, a travel distance value is calculated for each transaction in the transaction data based on the locations of the items and/or item categories in the layout. The calculated travel distances are added together and the result is divided by the total number of transactions in the transaction data, resulting in an average distance value for the layout.

At operation 414, if there are more inventory layouts to select (e.g., average distance values have not been calculated for all of the plurality of inventory layouts, etc.), the process returns to operation 410 to select another layout. Alternatively, if there are no more inventory layouts to select, the process proceeds to operation 416.

At operation 416, an inventory placement recommendation is generated based on the calculated average distance values of the plurality of inventory layouts. As described herein, the inventory placement recommendation may include the inventory layout with the lowest associated average distance value. In some examples, the inventory placement recommendation may include recommendation factors (e.g., average distance value of the recommended layout, degree to which the recommended layout improves the average distance value of the store, etc.) that provide information or data to users that indicate a reason for the recommendation. Alternatively, or additionally, the recommendation may be based on rearrangement cost estimates calculated for each of the inventory layouts indicating an estimated cost to rearrange the store from the current inventory layout to the potential inventory layout, as described herein. In some examples, the inventory placement recommendation may include multiple inventory layouts and associated recommendation factors, providing a user a choice between multiple layouts.

At operation 418, the generated inventory placement recommendation is output to a user interface. The user interface may be at a store device (e.g., store devices 106, etc.) or other computing device. The user interface may be a screen that displays at least one recommended inventory layout of the inventory placement recommendation. The display of the inventory layout may be as text, as a map, as a chart, or other representation. Outputting the recommendation to the user interface may further include displaying one or more recommendation factors as described herein.

In some examples, the inventory placement recommendation includes multiple inventory layouts that may be ranked or otherwise prioritized. The user interface may enable a user to select one of the multiple inventory layouts, causing the user interface to display additional information about the selected inventory layout (e.g., selecting an inventory layout from a text list of inventory layouts may cause a map of the selected inventory layout to be displayed and/or recommendation factors pertaining to the inventory layout, etc.). The user interface may enable the user to select a recommended inventory layout to be stored for later review and/or for use in physically implementing the inventory layout.

### Additional Example Scenarios

Aspects of the disclosure enable various additional scenarios, such as next described.

In an example, a user is trying to determine if an inventory rearrangement would improve the customer experience in a store. The user inputs container location data that represents the locations of each shelf, table, bin, and other container into an inventory placement system (e.g., system 100, etc.). The container location data further includes special attributes of certain containers, including containers that are near electrical sockets and a container that is a locked display cabinet. The user then inputs item location data and item category data into the system to define the current locations of all of the items in the store based on the containers in which the items are stored and/or displayed. The item category data further includes item constraints that an electronic item category should be displayed in range of electrical outlets and a video game item category should be stored and displayed in a locked display cabinet. The system also has access to historical transaction data from transactions that have occurred at the store for the past three years.

The user places a request with the system for an inventory placement recommendation for the store based on the transaction data of the store over the past six months. The system includes an inventory placement module as described herein. The inventory placement module obtains the inventory data supplied by the user and/or stored in the system and initiates the recommendation generation process. The store layout model is generated and the item category relationships are calculated based on the transactions that have occurred at the store over the past six months. Inventory layouts are then generated, with each layout satisfying the constraints that the electronic item category is placed in one of the containers near electrical sockets and the video game item category is placed in the locked display cabinet container. The average distance value for each generated inventory layout is calculated and an inventory placement recommendation is generated and provided to the user. The user views the inventory placement recommendation, which includes two different inventory layouts that offer improvement to the average travel distance of customers in the store. The first recommendation improves the average travel distance of customers by 15% with a rearrangement cost estimate of $1000. The second recommendation improves the average travel distance of customers by 12% but has a smaller rearrangement cost estimate of $500. The user reviews the changes that would be necessary for each recommended layout and chooses to implement the second layout in the store.

In another example, another user is opening a new store in a community near the store from the above example. The user has determined the locations of the shelves and other containers that will placed in the store. The user wants to sell the same categories of items as the store from the first example, so they obtain the item category data from that store. Further, the user obtains transaction data from the first store, as the new store does not have any transaction data yet. Additionally, the user obtains transaction data from a popular online store that sells a similar set of item categories. The user provides the collected inventory data to an inventory placement module as described herein to generate an inventory placement recommendation for the new store. As described above, the store layout model is generated, but the model is lacking item location data since the new store does not have any items in place yet. The item category relationships are calculated and inventory layouts are generated. An average distance value is calculated for each generated inventory layout, and an inventory placement recommendation is generated based on the average distance values. The recommendation includes only a single inventory layout that features the lowest average distance value. Since the new store has not been arranged yet, rearrangement cost estimates are not considered. The user uses the recommended layout when organizing the new store.

In a similar example, a user wants to determine an effective arrangement of a new store based on the inventory data from other stores. The user's new store does not have defined locations for the containers or the items and/or item categories. The user obtains historical transaction data from other nearby stores and provides an inventory placement module with inventory data including constraint and/or attribute data regarding containers and items that the users plans to have in the store. The inventory data does not include specific container location data. The store layout model generator of the inventory placement module may be used to generate multiple permutations of layouts for the containers in the store and inventory placement recommendations may generated based on each permutation of store layout model using the historical transaction data from the other stores. The inventory placement recommendations from the multiple permutations may then be compared to identify the most efficient store layout (e.g., the locations of the containers, etc.) and inventory layout.

### Exemplary Operating Environment

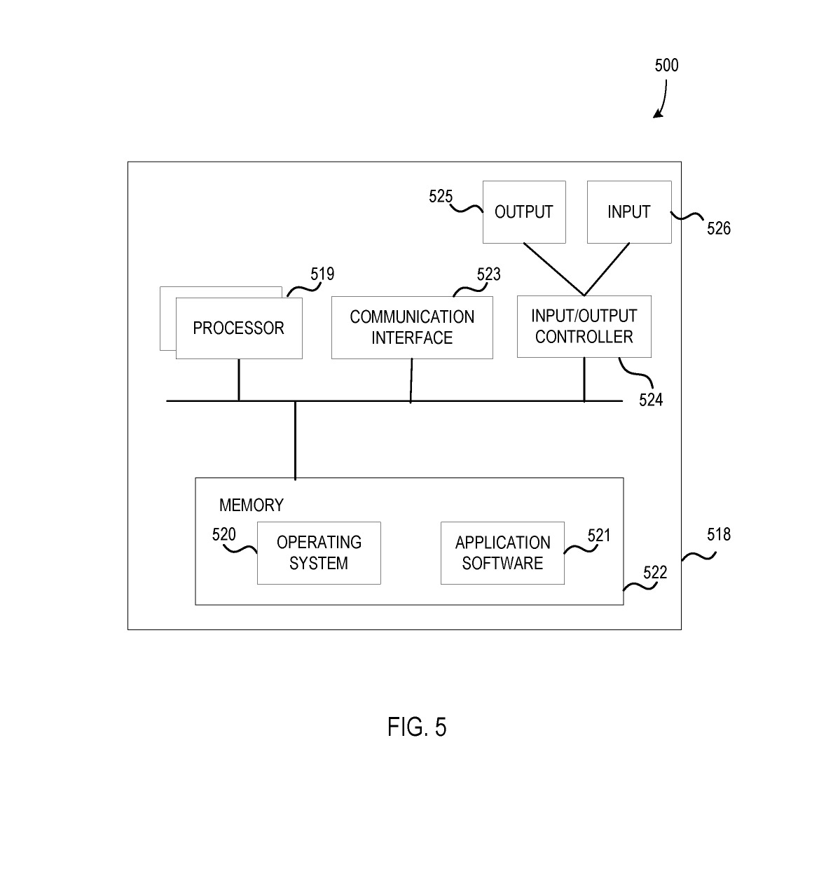

The present disclosure is operable with a computing apparatus according to an embodiment as a functional block diagram 500 in FIG. 5. In an embodiment, components of a computing apparatus 518 may be implemented as a part of an electronic device according to one or more embodiments described in this specification. The computing apparatus 518 comprises one or more processors 519 which may be microprocessors, controllers or any other suitable type of processors for processing computer executable instructions to control the operation of the electronic device. Platform software comprising an operating system 520 or any other suitable platform software may be provided on the apparatus 518 to enable application software 521 to be executed on the device. According to an embodiment, generating a store layout model, calculating item category relationships, generating inventory layouts, calculating average distance values based thereon, and generating inventory placement recommendations, as described herein may be accomplished by software.

Computer executable instructions may be provided using any computer-readable media that are accessible by the computing apparatus 518. Computer-readable media may include, for example, computer storage media such as a memory 522 and communications media. Computer storage media, such as a memory 522, include volatile and non-volatile, removable and non-removable media implemented in any method or technology for storage of information such as computer readable instructions, data structures, program modules or the like. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 522) is shown within the computing apparatus 518, it will be appreciated by a person skilled in the art, that the storage may be distributed or located remotely and accessed via a network or other communication link (e.g. using a communication interface 523).

The computing apparatus 518 may comprise an input/output controller 524 configured to output information to one or more output devices 525, for example a display or a speaker, which may be separate from or integral to the electronic device. The input/output controller 524 may also be configured to receive and process an input from one or more input devices 526, for example, a keyboard, a microphone or a touchpad. In one embodiment, the output device 525 may also act as the input device. An example of such a device may be a touch sensitive display. The input/output controller 524 may also output data to devices other than the output device, e.g. a locally connected printing device. In some embodiments, a user may provide input to the input device(s) 526 and/or receive output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

Alternatively, or in addition to the other examples described herein, examples include any combination of the following:
wherein the item category data includes item constraints defining location requirements for item categories;
wherein the plurality of inventory layouts is generated based on the item constraints such that the item constraints are satisfied in the plurality of inventory layouts;
wherein the item constraints are based on at least one of category size, item size, a category-specific container requirement, and user-defined constraints;
wherein the inventory placement recommendation includes a mapping of a number of item categories of the item category data mapped to a number of containers of the container location data;
wherein the inventory placement recommendation includes at least one indicator of an item category to be moved based on a comparison of the inventory placement recommendation to the store layout model;
calculating a plurality of rearrangement cost estimates associated with the plurality of inventory layouts based on the container location data and the item location data, wherein generating the inventory placement recommendation is based on the calculated plurality of rearrangement cost estimates;
wherein generating the inventory placement recommendation includes providing, as the inventory placement recommendation, the inventory layout of the plurality of inventory layouts with the lowest average distance value and a rearrangement cost estimate below a defined rearrangement cost threshold.
wherein the plurality of rearrangement cost estimates is based on at least one of a quantity of item categories to move in the inventory layout, a distance of item categories to move in the inventory layout, and a cost factor of item categories to move in the inventory layout.
wherein the transaction data includes transactions from at least one of a defined time period in the immediate past, and one or more historical seasonal time periods.
wherein the transaction data includes transactions associated with at least one of the store, at least one other store within a defined proximity of the store, or at least one online store.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for obtaining inventory data associated with a store; means for generating a store layout model of a store; means for calculating a number of item category relationships; means for generating a plurality of inventory layouts based on store layout models and item category relationships; means for calculating average distance values associated with inventory layouts; and means for generating an inventory placement recommendation based on average distance values of inventory layouts. The illustrated one or more processors 519 together with the computer program code stored in memory 522 constitute exemplary processing means for generating some or all possible permutations of inventory layouts based on a store layout model and item category relationships and calculating average distance values for each inventory layout based on a set of transaction data, as described herein.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of ” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for providing inventory placement recommendations, the system comprising:
at least one processor;
at least one memory communicatively coupled to the at least one processor; and comprising container location data of the store, item location data indicating the location of items in the store based on the container location data, item category data, and transaction data indicating sets of items purchased in past transaction
an inventory placement module stored on the at least one memory and executed by the at least one processor to:
obtain inventory data associated with an individual store, the inventory data including container location data, item location data, item category data, and transaction data;
generate a store layout model of the individual store based on the container location data and the item location data;
calculate a number of item category relationships based on the transaction data and the item category data;
generate a plurality of inventory layouts based on the generated store layout model and the calculated number of item category relationships;
calculate individual average distance values for each of the individual inventory layouts of the plurality of inventory layouts based on the transaction data, a calculated individual average distance value of an individual inventory layout indicating an average distance traveled in a store arranged according to the individual inventory layout to obtain items of transactions of the transaction data; and
generate an inventory placement recommendation based on the calculated individual average distance values of the plurality of inventory layouts.

2. The system of claim 1, wherein the item category data includes item constraints defining location requirements for item categories; and
wherein the plurality of inventory layouts is generated based on the item constraints such that the item constraints are satisfied in the plurality of inventory layouts.

3. The system of claim 2, wherein the item constraints are based on at least one of category size, item size, a category-specific container requirement, and user-defined constraints.

4. The system of claim 1, wherein the inventory placement recommendation includes a mapping of a number of item categories of the item category data mapped to a number of containers of the container location data.

5. The system of claim 4, wherein the inventory placement recommendation includes at least one indicator of an item category to be moved based on a comparison of the inventory placement recommendation to the store layout model.

6. The system of claim 1, wherein the at least one memory and computer program code are configured to, with the at least one processor, further cause the at least one processor to:
calculate a plurality of rearrangement cost estimates associated with the plurality of inventory layouts based on the container location data and the item location data, wherein generating the inventory placement recommendation is based on the calculated plurality of rearrangement cost estimates.

7. The system of claim 6, wherein generating the inventory placement recommendation includes providing, as the inventory placement recommendation, the inventory layout of the plurality of inventory layouts with the lowest average distance value and a rearrangement cost estimate below a defined rearrangement cost threshold.

8. The system of claim 6, wherein the plurality of rearrangement cost estimates is based on at least one of a quantity of item categories to move in the inventory layout, a distance of item categories to move in the inventory layout, and a cost factor of item categories to move in the inventory layout.

9. A computerized method for providing inventory placement recommendations, the computerized method comprising:
obtaining, by an inventory placement component, inventory data associated with an individual store, the inventory data including container location data, item location data, item category data, and transaction data;
generating, by the inventory placement component, a store layout model of the store based on the container location data and the item location data;
calculating, by the inventory placement component, a number of item category relationships based on the transaction data and the item category data;
generating, by the inventory placement component, a plurality of inventory layouts based on the generated store layout model and the calculated item category relationships;
calculating, by the inventory placement component, individual average distance values for each of the individual inventory layouts of the plurality of inventory layouts based on the transaction data, a calculated individual average distance value of an individual inventory layout indicating an average distance traveled in a store arranged according to the individual inventory layout to obtain items of transactions of the transaction data; and
generating, by the inventory placement component, an inventory placement recommendation based on the calculated individual average distance values of the plurality of inventory layouts.

10. The computerized method of claim 9, wherein the item category data includes item constraints defining location requirements for item categories; and wherein the plurality of inventory layouts is generated based on the item constraints such that the item constraints are satisfied in the plurality of inventory layouts.

11. The computerized method of claim 10, wherein the item constraints are based on at least one of category size, item size, a category-specific container requirement, and user-defined constraints.

12. The computerized method of claim 9, wherein the transaction data includes transactions from at least one of a defined time period in the immediate past, and one or more historical seasonal time periods.

13. The computerized method of claim 9, wherein the transaction data includes transactions associated with at least one of the store, at least one other store within a defined proximity of the store, or at least one online store.

14. The computerized method of claim 9, further comprising:
calculating, by the processor, a plurality of rearrangement cost estimates associated with the plurality of inventory layouts based on the container location data and the item location data, wherein generating the inventory placement recommendation is based on the calculated plurality of rearrangement cost estimates.

15. The computerized method of claim 14, wherein generating the inventory placement recommendation includes providing, as the inventory placement recommendation, the inventory layout of the plurality of inventory layouts with the lowest average distance value and a rearrangement cost estimate below a defined rearrangement cost threshold.

16. The computerized method of claim 14, wherein the plurality of rearrangement cost estimates is based on at least one of a quantity of item categories to move in the inventory layout, a distance of item categories to move in the inventory layout, and a cost factor of item categories to move in the inventory layout.

17. The computerized method of claim 9, wherein an item category relationship between a first item category and a second item category is calculated based on a sum of transactions including items from the first item category and the second item category.

18. One or more computer storage media having computer-executable instructions for providing inventory placement recommendations that, upon execution by a processor, cause the processor to at least:
obtain inventory data, the inventory data including container location data associated with an individual store, transaction data associated with past transactions at stores within a defined proximity of the individual store, and item category data associated with items of the transaction data;
generate a store layout model of the individual store based on the container location data;
calculate a number of item category relationships based on the transaction data and the item category data;
generate a plurality of inventory layouts based on the generated store layout model and the calculated number of item category relationships;
calculate individual average distance values for each of the individual inventory layouts of the plurality of inventory layouts based on the transaction data, a calculated individual average distance value of an individual inventory layout indicating an average distance traveled in a store arranged according to the individual inventory layout to obtain items of transactions of the transaction data; and
generate an inventory placement recommendation based on the calculated individual average distance values of the plurality of inventory layouts.

19. The one or more computer storage media of claim 18, wherein the item category data includes item constraints associated with the individual store defining location requirements for item categories, wherein the plurality of inventory layouts is generated based on the item constraints such that the item constraints are satisfied in the plurality of inventory layouts.

20. The one or more computer storage media of claim 19, wherein the item constraints are based on at least one of category size, item size, a category-specific container requirement, and user-defined constraints.
